(19) United States
(12) Patent Application Publication
(10) Pub. No.: US 2011/0134021 A1
(43) Pub. Date: Jun. 9, 2011

(54) METHOD AND APPARATUS FOR LED DRIVER COLOR-SEQUENTIAL SCAN

(75) Inventors: Hans Schmitz, Eindhoven (NL); Gian Hoogzaad, Numegen (NL); Matheus J. G. Lammers, Eindhoven (NL)

(73) Assignee: NXP B.V., Eindhoven (NL)

(21) Appl. No.: 12/633,230

(22) Filed: Dec. 8, 2009

(51) Int. Cl. G09G 3/32

(52) U.S. Cl. 345/83

(57) ABSTRACT

A light emitting diode (LED) driver for an LED backlight of a color-sequential liquid crystal display (LCD) and method for operation thereof includes a plurality of LED strings having one or more LEDs emitting light at wavelength corresponding to a predetermined color. A plurality of switches is respectively coupled to the plurality of LED strings. A current source is switchably coupled respectively and sequentially to each of the plurality of switches by control signals to open and close the switches in a pattern that illuminates the LED strings. The switches are opened and closed sequentially to permit a respective LED string to provide an output of the predetermined color for a specific period of time such that a total output of the plurality of LED strings provides an output having the desired overall color perceived through temporal integration of an output of each respective LED string.

The present invention relates to color sequential display schemes, including but not limited to color sequential displays employing liquid crystal displays (LCD's) and thin film transistor (TFT) LCD's. More particularly, the present invention relates to driving circuits for color sequential displays.

The popularity of flat panel displays and their application in computer monitors and High Definition Televisions has grown to unprecedented heights. In particular, there has been a growing interest in flat panel displays comprising liquid crystals, and such LCD's have now surpassed the cathode ray tube (CRT) in sales as the preferred choice of consumers worldwide.

One of the reasons that LCDs have become the most popular of flat panel displays is a combination of their brightness, durability and reduced cost of construction, which has made such displays more affordable than ever.

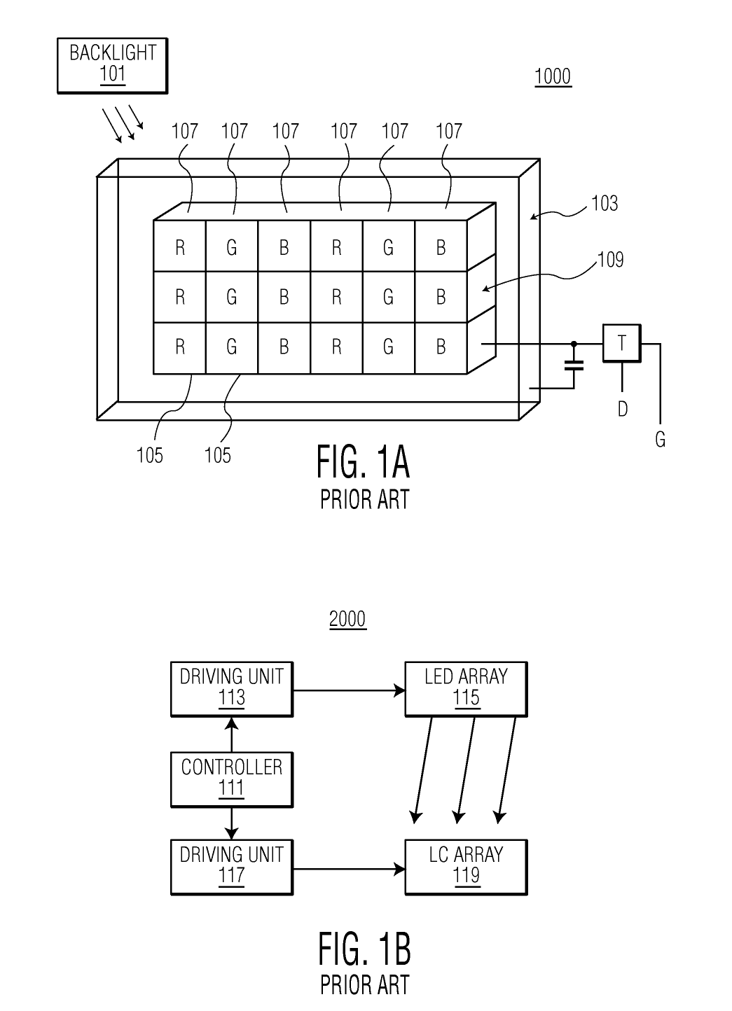

FIG. 1A shows a conventional example of LCD technology. LCD 1000 typically includes a backlight 101 that illuminates a liquid crystal layer 103 having an array of pixels, and color filters 105 are arranged in front of each pixel. Thin-Film Transistor (TFT) 109 technology is commonly used, in which each pixel includes a transistor and capacitor so as to assist in increasing the contrast rating, with “D” representing the Data Line and “G” representing the gate line, and control of each pixel involves addressing a specific column (e.g., via address lines 107) and individually activating each pixel in that row with a timed address pulse on the horizontal plane. The color filters used in conventional LCDs, as well as any polarizing filters, increase the cost and size of such display units.

Recent innovations in LCD technology include color-sequential scanning. More particularly, color-sequential technology is a new technology that is gaining favor because it uses less power than traditional LCD technology and does not require color filters (an example of such filters 105 is shown in FIG. 1A), and thereby provides for a brighter display at a reduced cost of manufacture. As color filters typically represent about 20% of the LCD's material costs, construction without color filters results in a significant savings and results in a wider color gamut than conventional LCDs. In addition, fewer pixels are required in the color-sequential system, further reducing the cost of production.

As shown in FIG. 1B, operation color-sequential technology of an LCD 2000 typically includes a controller 111 controlling a driving unit 113 to drive colored light emitting diodes (LEDs, typically red, green and blue) in array 115 in a color-sequential manner to produce a particular color. Meanwhile, driving unit 117 drives the liquid crystal (LC) array 119, which without color filters, can function as a gray level device that is illuminated with the colors provided by the associated LEDs. Color-sequential technology takes advantage of the fact that the human eye cannot distinguish the brief use of the individual colors that are turned on and off and instead sees a blended color of the desired hue (temporal integration).

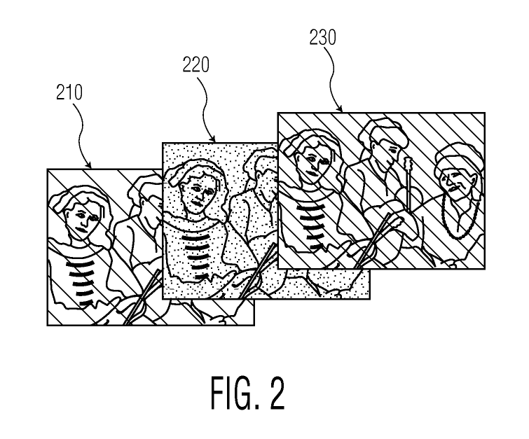

FIG. 2 shows an example of a color-sequential scan of a picture with frame displays 210, 220 and 230 showing the picture scanned in red, green, and blue, respectively. Human sight will perceive one picture with blended colors, of course, and not three discrete displays having separate colors as shown in this drawing because of the frequency by which the frames are illuminated.

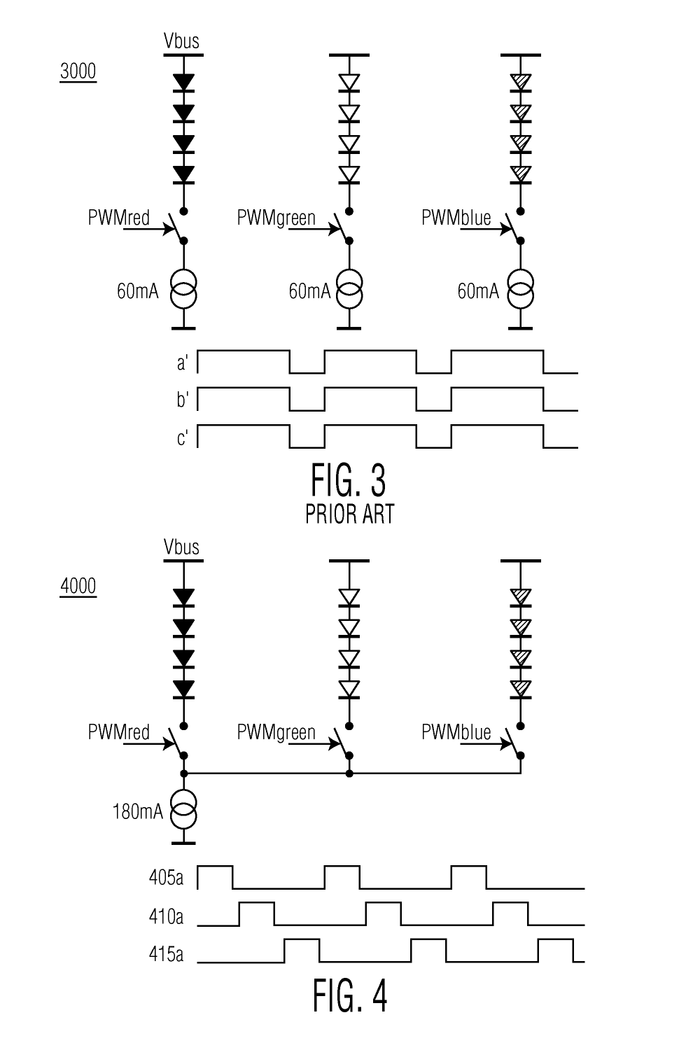

FIG. 3 shows a conventional driver circuit 3000 for an RGB mixer LED backlight that is used in a color-sequential LCD. Strings of red 305, green 310, and blue 315 LEDs, respectively, and pulse width modulated (PWM) switches 320, 325, 330 switch respective currents sources (a), (b) and (c) on and off to perform selective dimming for each of the color values to permit the colors to be mixed. The PWM signals (a′), (b′), and (c′) to control respectively the switches for the red, green and blue LED strings are shown below the schematic of the driving circuit. Accordingly, there is a one-to-one ratio of current sources to LED strings. In FIG. 3 while it appears that all switches are opened at exactly the same time, the switches open and close that fast that the eye does not notice. In principle the opening/close patterns are allowed to be shifted in time, but this may not always be done to keep the system simple. However, the duration that switches are open or close differ per channel, so the pulse width of the pulses change over time and they can be different for red, green and blue channel at the same time. In FIG. 3, if the patterns were shifted, the timings for the switches would be overlapping.

However, as color-sequential technology takes advantage the temporal integration of images as perceived by the human brain, the LEDs are turned on and off for a short period of time, and the combination of LEDs turned on and off are repeated at a frequency sufficient so that viewers preferably can perceive the full color image comprised of the different color frames (such as shown in FIG. 2), even though the LEDs are not all on at a given time. Thus, by reducing the number of current sources for the LED strings, the cost and size of the circuitry could be reduced.

The present invention provides a way to reduce the costs of construction and size of the color-sequential scan displays by simplifying the scan display circuitry by reducing the current sources in a three color string (such as RGB) by two thirds, so that one current source rather than three current sources are used. In cases where there are more than three strings of colors used, the present invention's use of a single current source in place of multiple current sources also provides a savings that can be even greater than the reduction using the RGB strings of LEDs and the common current source.

In an exemplary aspect of the present invention, a light emitting diode (LED) driver for an LED backlight of a color-sequential liquid crystal display (LCD) includes a plurality of LED strings of respectively different predetermined colors, wherein each LED string includes one or more LEDs emitting light at a wavelength substantially corresponding to a particular predetermined color; a plurality of switches respectively coupled to the plurality of LED strings so that each LED string is coupled to a respective switch, wherein the plural switches are opened and closed according to control output according to a respective control signal; a current source is switchably coupled respectively and sequentially to each of the plurality switches strings to provide current to control operation of each of the plurality of LED strings to output light emitted at the particular predetermined color in a sequence color. The respective control signal opens and closes a respective switch from the plurality of switches sequentially to permit a respective LED string to provide an output of the particular predetermined color for a specific period of time. Preferably, this can be timed such that a total output of the plurality of LED strings provides an output having a desired overall color and intensity which can be perceived by a viewer during a temporal integration of an output of each respective LED string.

The respective control signals preferably comprise pulse width modulated (PWM) control signals, although other controls schemes also could be used.

In addition, according to an exemplary aspect of the present invention, when a number of the plurality of LED strings is equal to “n” and a frequency of switching time of the respective control signal occurs at a frequency n times higher than a control signal frequency for operating LED strings in which each LED string has its own respective current source, the current source operates at a value of current about n times that of a value of current used for operating LED strings in which each LED string has its own respective current source.

For example, a three-string set of LEDs having respective colors such as red, green and blue to blend into a plurality of other colors would typically have, for purposes of illustration and explanation, supplied current of 60 ma from each operating current source (a), (b) and (c) shown in FIG. 3, whereas the sole current source 440 in FIG. 4 according to a preferred mode of the present invention would operate at about 180 ma, and the control signals (PWM signals in this case) that cause the switches to open and close would have a frequency that is three times greater than the frequency of the PWM control signals shown in the conventional configuration of FIG. 3. However, it is not required to increase the current of the current source (although such an increase is not excluded), and the value of the single current source in FIG. 4 (color sequential) can be about the same as one of the three current sources in FIG. 3.

Another way to describe this arrangement is that each control signal is switched with a frequency such that, during a period of time “T”, the LED string which operates in response to that control signal is activated for fraction of the time “T” (approximately T/n, where “n” is an integer of value 2 or greater). To compensate for the light which is not produced by the LED string during the balance of the time T (that being time approximately (T−T/n), the current source provides current to each active LED string at a level such that the intensity of light emitted by the associated activated LED string is correspondingly increased.

The above and other aspects, features and advantages of certain exemplary embodiments of the present invention will become more apparent from the following description taken in conjunction with the accompanying drawing, in which:

FIG. 1A depicts the red, green and blue color filters used in a conventional Liquid Crystal Display employing thin film technology and a backlight.

FIG. 1B shows an overview of an LCD device employing color sequential scanning.

FIG. 2 is an illustration of a conventional driver circuit for an RGB mixer LED backlight used in Liquid Crystal Displays;

FIG. 3 is illustration of a multiple current source driver circuit for a color-sequential scan RGB mixer LED backlight according to the known art;

FIG. 4 is an illustration of a portion of the circuitry for driving an LCD array including the color-sequential driver circuit according to an exemplary embodiment of the present invention;

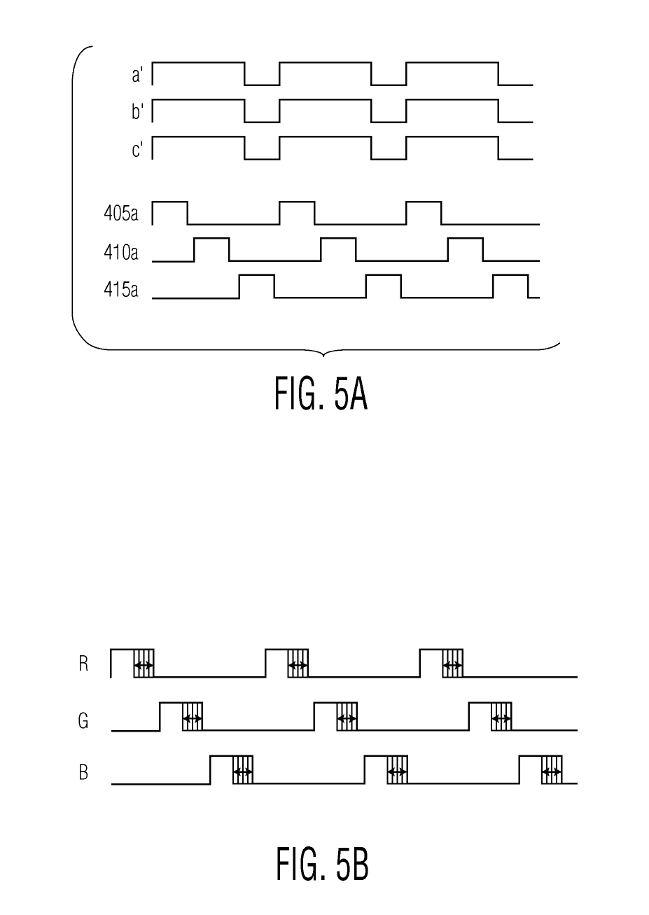

FIG. 5A is an illustrative drawing showing a comparison of the PWM signals of a conventional color-sequential scan as shown in FIG. 3, together with the color-sequential scan according to the present invention, and FIG. 5B shows the details of the driving signals in FIG. 5A;

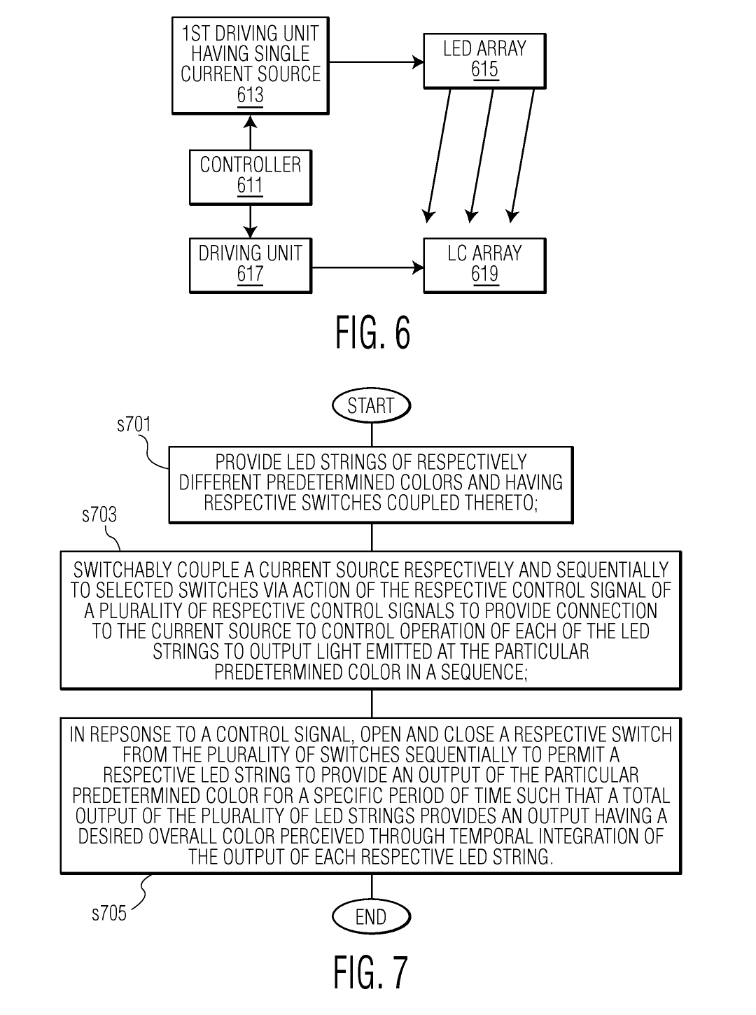

FIG. 6 is a schematic of a Liquid Crystal Display device according to an exemplary embodiment of the present invention; and

FIG. 7 is a flowchart providing a general overview of a method according to the present invention

A person or ordinary skill in the art should understand and appreciate that the drawings and their accompanying description have been provided for purposes of illustration and not for limiting the claimed invention to the examples shown and described herein. In addition, well-known configurations and detailed descriptions of well-known functions and structures incorporated herein may be omitted to avoid obscuring appreciation of the subject matter of the present invention by a person of ordinary skill in the art.

Now referring to FIG. 4, driver circuit 4000 for an LED backlight of a color-sequential LCD according to the present invention, which includes a plurality of LED strings 405, 410, 415, each transmitting light at a respective wavelength, is shown. In this example, the three colors red, green and blue are used. Of course, a person of ordinary skill in the art understands and appreciates that other colors (for example, cyan, magenta, yellow), or more or fewer colors than RGB can be provided. However, in the case of displays, RGB has been in standard use, and so, for convenience only and not limitation, those colors have been shown. In addition, other variations within the spirit and scope of the invention include: 1) the location of the switch can be at the bottom of the LED string or at the top of the LED string; 2) the current source can be of the linear type, or of the switch-mode type, where the switch-mode type is more power-efficient in general, but also specifically with regard to this invention since different colored LED strings typically have different forward voltages which results in high dissipation with linear current sources, but not with switch-mode current sources; 3) LED strings can be connected to ground or to a supply (bus) voltage; 4) in the case of a supply (bus) voltage, the bus voltages can be different for different colors (mitigating the power dissipation issue mentioned above). In other words, this invention encompasses constructional and operational variations which may be made to improve performance in view of the electrical and/or optical properties of the system components.

Still referring to FIG. 4, switches 420, 425, 430 are sequentially opened and closed according to a pulse width modulation signal pattern shown by 405a, 405b, and 405c, respectively. In order for the eye to perceive the same colors as in FIG. 3, where the ratio of current sources to LED driver strings is 1:1, the driver circuit according to the present invention here provides the PWM signals at three times the frequency of the PWM signals shown in FIG. 3. As this switching might be too fast for the eye to perceive the color if the intensity of the emitted light is approximately that of a conventional device, the amount of current in the current source 440 is preferably approximately three times that of the respective current sources shown in FIG. 3 (this way, the total amount of light emitted is approximately equal to the amount emitted by a multi-string LED array driven in a conventional manner using a discrete, dedicated current supply for each string). The increased value of current (in this example being about three times that of an individual current source of FIG. 3) of the current source shown in FIG. 4 according to the present invention provides as much light as the three sources do despite the switches being opened and closed at three times the frequency of the opening and closing in the device shown in FIG. 3. If the relationship between current and the amount of light emitted by the LEDs is non-linear, the current can be suitably increased (or decreased) so that the intensity of the emitted light will be readily perceptible by and be pleasing to a viewer's eye. Again, according to the present invention, the current for color sequential systems does not have to be increased a factor of n (FIG. 4) relative to the prior art (FIG. 3) and the current can be about the same as one of the three current sources of FIG. 3. It should also be noted that the removal of color filters in the color sequential system provide for increased aperture that at least partially counter-balances the negative duty-cycle effect on the brightness because LEDs cannot be on 100% of the time in conventional color sequential systems. In other words, while this invention extends to systems where driving current is increased, it also applies to systems where driving current is not increased, or even is reduced.

FIG. 5A is a comparison of the PWM signals of a conventional color-sequential scan as shown in FIG. 3, versus the PWM signals of the driving circuit for color-sequential scan according to the present invention shown in FIG. 4. FIG. 5b represents the timing for color-sequential scan which shows how the PWM signals change over time. The respective PWM control signals 405a, 410a, and 415a for the red, green and blue LED driver strings 405, 410 and 415 have a frequency three times that of the PWM signals for the conventional driver circuit. It is also again noted that the value of current of the sole current source according to the present invention is preferably three times that of the value of the individual current sources of the conventional circuit. Again, a person of ordinary skill in the art should appreciate that in the cases where there can be more than three colors of strings, a current source driver circuit according to the present invention would preferably, for example, (in the case of four basic colors with one current source) have PWM signals at 4 times the frequency of the conventional drive circuit, and the sole current source would have a current value of about four times the value of the respective current source in each of the of LED strings in the conventional circuitry having a 1:1 ratio of current sources to LED strings. In addition, the colors of the LED strings used as primary colors for display are not limited to RGB; for example, any other suitable color system, such as cyan, yellow and magenta, and any suitable number of colors, also could be used.

It is also within the spirit and scope of the invention that next to the colored LEDs, (such as the RGB), there can be an extra string of white LEDs, as white can be used more than other colors in certain applications, and it may be more desirable to include a string of white LEDs rather than mix multiple wavelengths of different LEDs to create white light. Additionally, one or more of the RGB strings could be omitted. The white LEDs could include, but are in no way limited to a color LED (such as for example blue Indium-Gallium-Nitride InGaN) coated with, for example, suitable phosphor, so as to permit tuning of the light. The invention even can extend to a system using only white LEDs, and a single color of LEDs.

FIG. 6 is a schematic of a Liquid Crystal Display device according to an exemplary embodiment of the present invention.

Referring now to FIG. 6, the example shown may be, for example, an LCD provided in a monitor, or a television set, or a handheld device using an LCD, such as a PDA, mobile telephones, consoles for electronic games, notebook computers, just to name a few possible non-limiting examples of the many devices that may employ the presently claimed invention.

In addition, while the examples shown and described herein involve PWM control signals, the present invention is not limited to a particular type of control signal, and only requires that the control signal can open and close the switches in the timewise manner described herein.

The controller 611 is operatively coupled to both driving unit 617 for driving the liquid crystal array 619, and to the first driving unit 613 having a current source according to the present invention for driving the LED array 615 of a backlight. The controller 611 may receive from a formatting unit the RGB information, or may include the formatting information. Preferably, the LED array 615 typically including LED strings of color sub-pixel elements is arranged in alignment with the LC array 619 (typically behind the LC array 619). The LEDs are activated to illuminate in a pattern so as to transmit colored light to the LC cells to permit the LC to output color frames having sequences of, in this case, red, green and blue LED strings having an on and off pattern such that the frames are perceived as blended colors according to a color selection provided by the controller. To drive the LED strings in LED array 615 the current source of driving unit 613 operates at a current typically three times greater than devices having a 1:1 ratio of current sources per LED string. The driving unit 613 opens and closes switches to activate selected LED strings via PWM signals. The PWM signals typically open and close at three times the frequency of devices having three different color strings of LEDs and a 1:1 ratio of current sources to LED strings.

Finally, FIG. 7 is a flowchart providing a general overview of a method according to the present invention. As shown in step 701a plurality of LED strings of different predetermined colors and coupled to a respective plurality of switches are provided.

At step 703, a current source is switchably coupled to a selected one of the plurality of switches, respectively and sequentially via action of respective control signals so as to provide connection of the associated one of the respective LED strings to the current source to output light at the times it is desired to display a particular predetermined color (corresponding to that LED string) in a sequence.

At step 705, the respective switch is opened and closed to provide an output of the particular color for a specified period of time such that a total output of the plurality of LEDs over a predetermined time period provides an overall color that can be perceived by a viewer during a temporal integration of an output of each respective LED string. As previously discussed, the frequency and brightness of the LED string outputs are required to be sufficient to be seen by the human eye such that the brain perceives a blended color formed by the output of light from the plurality of strings.

Accordingly, the present invention provides a cost reduction in the construction of an LCD device by using less silicon, yet still provides a color-sequential display in which the colors are perceived as in conventional color-sequential displays.

In addition, the above-described methods according to the present invention can be realized in hardware or as software or computer code that can be stored as machine readable code in a medium such as a ROM, an RAM, a floppy disk, a hard disk, a flash memory, or a magneto-optical disk, or downloaded over a network, so that the methods described herein can be rendered in such software using a general purpose microprocessor, general purpose computer, or a special processor or in programmable or dedicated hardware, such as an ASIC or FPGA.

As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

The present invention has been described with respect to particular embodiments and with reference to certain drawings, but the invention is not limited thereto, but rather, is set forth only by the claims. The drawings described are only schematic and are non-limiting. In the drawings, for illustrative purposes, the size of some of the elements may be exaggerated and not drawn to a particular scale. Where the term “comprising” is used in the present description and claims, it does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. This expression signifies that, with respect to the present invention, the only relevant components of the device are A and B.

Furthermore, the terms “first”, “second”, “third” and the like, if used in the description and in the claims, are provided for distinguishing between similar elements and not necessarily for describing a sequential or chronological order. It is to be understood that the terms so used are interchangeable under appropriate circumstances (unless clearly disclosed otherwise) and that the embodiments of the invention described herein are capable of operation in other sequences and/or arrangements than are described or illustrated herein.

What is claimed is:

1. A light emitting diode (LED) driver for an LED, the LED driver comprising:
a plurality of LED strings of respectively different predetermined colors, wherein each LED string includes at least one LED emitting light at a wavelength substantially corresponding to a particular predetermined color;
a plurality of switches respectively coupled to corresponding ones of the plurality of LED strings so that each said LED string is coupled to a respective switch, wherein said plurality of switches are opened and closed in response to a corresponding control signal; and
a current source that is switchably coupled respectively to each of the plurality of switches via action of the corresponding control signals to provide successively current to each of the plurality of LED strings to output light emitted at the particular predetermined color in a color sequence.

2. The driver according to claim 1 wherein the plurality of LED strings includes a string of white LEDs.

3. The driver according to claim 1, wherein each corresponding control signal opens and closes a respective switch from said plurality of switches sequentially to permit a respective LED string to provide an output of the particular predetermined color for a specific period of time such that a total output of the plurality of LED strings has a desired overall color through temporal integration of an output of each respective LED string; and
wherein a number of the plurality of LED strings is equal to “n” and n is an integer having a value of at least 2,
wherein each control signal is switched with a frequency such that, during a period of time “T”, the associated LED string is activated for a cumulative duration that is approximately T/n, and
wherein the current source provides current to each active LED string at a level such that an intensity of light emitted by the associated activated LED string is increased to compensate for that associated activated LED string not being activated during a portion of the period that is approximately T−(T/n).

4. The driver according to claim 1, wherein the control signals comprise pulse width modulated (PWM) control signals.

5. The driver according to claim 1, wherein the plurality of LED strings comprises three LED strings, and wherein each LED string comprises one of red, green and blue.

6. The driver according to claim 1, wherein the plurality of LED strings comprises three LED strings, and wherein each LED string comprises a different color.

7. The driver according to claim 1, wherein the plurality of LED strings comprises at least four LED strings, and wherein each LED string comprises a different color.

8. An LCD apparatus comprising:
the LED driver according to claim 1, wherein the LED strings form an LED array,
a driving unit for driving a liquid crystal (LC) array to display a desired output of light;
a controller for providing RGB control information to the LED driver to drive the LED array,
wherein the LED array is substantially aligned with the LC array so that the LED array transmits light in a particular sequence and with a particular color to be projected by the LC array sequentially as frames in a color-sequential display, and
wherein the control signals include pulse width modulated (PWM) control signals.

9. The LCD apparatus according to claim 8, wherein each respective control signal opens and closes a respective switch from said plurality of switches sequentially to permit an associated LED string to provide an output of the particular predetermined color for a specific period of time such that a total output of the plurality of LED strings provides an output having a desired overall color perceived during a temporal integration of an output of each respective LED string,
wherein a number of the plurality of LED strings is equal to “n” and n is an integer having a value of at least 2,
wherein each control signal is switched with a frequency such that, during a period of time “T”, the associated LED string is activated for a cumulative duration that is approximately T/n, and
wherein the current source provides current to each active LED string at a level such that an intensity of light emitted by the associated activated LED string is increased to compensate for that associated activated LED string not being activated during a portion of the period that is approximately T−(T/n).

10. The LCD apparatus according to claim 8, wherein the plurality of LED strings comprises three LED strings, and wherein each LED string comprises one of red, green and blue.

11. The LCD apparatus according to claim 9, wherein the plurality of LED strings comprises three LED strings, and wherein each LED string comprises one of red, green and blue.

12. The LCD apparatus according to claim 8, wherein the plurality of LED strings comprises three LED strings, and wherein each LED string comprises a different color.

13. The LCD apparatus according to claim 8, wherein the plurality of LED strings comprises at least four LED strings, and wherein each LED string comprises a different color, and at least one of the LED strings comprises white.

14. A method of providing color sequential control of a light emitting diode (LED) driver, said method comprising:
providing a plurality of LED strings of respectively different predetermined colors, wherein each LED string comprises at least one LED emitting light at a wavelength substantially corresponding to a particular predetermined color;
respectively coupling a plurality of switches to the plurality of LED strings so that each said LED string is coupled to a respective switch, wherein said plurality of switches are opened and closed according to a respective control signal;
switchably coupling a current source to each of the plurality of switches in response to the respective control signal of a plurality of respective control signals to provide successive current to each of the plurality of LED strings to output light emitted at the particular predetermined color in a color sequence;
wherein each corresponding control signal opens and closes a respective switch from said plurality of switches sequentially to permit a respective LED string to provide an output of the particular predetermined color for a specific period of time such that a total output of the plurality of LED strings has a desired overall color through temporal integration of an output of each respective LED string.

15. The method according to claim 14, wherein a number of the plurality of LED strings is equal to “n” and n is an integer having a value of at least 2; and
wherein each control signal is switched with a frequency such that, during a period of time “T”, the associated LED string is activated for a cumulative duration that is approximately T/n, and
wherein the current source provides current to each active LED string at a level such that an intensity of light emitted by the associated activated LED string is increased to compensate for that associated activated LED string not being activated during a portion of the period that is approximately T−(T/n).

16. The method according to claim 14, wherein the control signals comprise pulse width modulated (PWM) control signals.

17. The method according to claim 14, wherein the plurality of LED strings comprises three LED strings, and wherein each LED string comprises one of red, green and blue.

18. The method according to claim 15, wherein the plurality of LED strings comprises three LED strings, and wherein each LED string comprises one of red, green and blue.

19. The method according to claim 14, wherein the plurality of LED strings comprises three LED strings, and wherein each LED string comprises a different color.

20. The method according to claim 14, wherein the plurality of LED strings comprises at least four LED strings, and wherein each LED string comprises a different color, and at least one LED string comprises white.
